(19) United States
(12) Patent Application Publication
(10) Pub. No.: US 2023/0207788 A1
(43) Pub. Date: Jun. 29, 2023

(54) METHOD FOR LAMINATING A LITHIUM METAL ANODE

(71) Applicant: GM GLOBAL TECHNOLOGY OPERATIONS LLC, Detroit, MI (US)

(72) Inventors: Wai Ping Gloria Tam, Troy, MI (US); Anil K. Sachdev, Rochester Hills, MI (US)

(73) Assignee: GM GLOBAL TECHNOLOGY OPERATIONS LLC, Detroit, MI (US)

(21) Appl. No.: 17/560,454

(22) Filed: Dec. 23, 2021

(51) Int. Cl. H01M 4/38; H01M 4/04; H01M 4/36

(52) U.S. Cl. CPC H01M 4/382; H01M 4/0404; H01M 4/366

(57) ABSTRACT

A method for laminating a lithium metal anode is provided. The method includes procuring a current collector, including a portion of the current collector to be covered with a lithium foil lamination, and procuring a plurality of lithium foil portions. The plurality of lithium foil portions each include a length configured for matching one of a length of the portion of the current collector to be covered with the lithium foil lamination or a width of the portion of the current collector to be covered with the lithium foil lamination. The method further includes disposing the plurality of lithium foil portions upon the portion of the current collector to be covered with the lithium foil lamination, wherein the plurality of lithium foil portions is arranged side-by-side, and applying heat and pressure to join the plurality of lithium foil portions to the current collector.

### INTRODUCTION

The disclosure generally relates to a method for laminating a lithium metal anode.

A battery cell includes an anode, a cathode, an electrolyte, and a separator. The anode and the cathode include reactive materials which exchange ions through the electrolyte and the separator for the purpose of providing an electrical current through an attached circuit. In one embodiment, an anode may include a current collector, for example, a copper current collector, and a lithium coating upon the copper current collector.

### SUMMARY

A method for laminating a lithium metal anode is provided. The method includes procuring a current collector, including a portion of the current collector to be covered with a lithium foil lamination, and procuring a plurality of lithium foil portions. The plurality of lithium foil portions each include a length configured for matching one of a length of the portion of the current collector to be covered with the lithium foil lamination or a width of the portion of the current collector to be covered with the lithium foil lamination. The method further includes disposing the plurality of lithium foil portions upon the portion of the current collector to be covered with the lithium foil lamination, wherein the plurality of lithium foil portions is arranged side-by-side, and applying heat and pressure to join the plurality of lithium foil portions to the current collector.

In some embodiments, the plurality of lithium foil portions each include a rectangular shape including two elongated sides and two relatively narrow sides and a longitudinal axis defined by the two elongated sides. The current collector is rectangular in shape including a longitudinal axis of the current collector.

In some embodiments, disposing the plurality of lithium foil portions upon the portion of the current collector to be covered with the lithium foil lamination includes arranging the plurality of lithium foil portions such that the longitudinal axis of each of the plurality of lithium foil portions is parallel to the longitudinal axis of the current collector.

In some embodiments, disposing the plurality of lithium foil portions upon the portion of the current collector to be covered with the lithium foil lamination includes arranging the plurality of lithium foil portions such that the longitudinal axis of each of the plurality of lithium foil portions is perpendicular to the longitudinal axis of the current collector.

In some embodiments, the plurality of lithium foil portions each include a rectangular shape including two elongated sides and two relatively narrow sides and a longitudinal axis defined by the two elongated sides. The portion of current collector to be covered with the lithium foil lamination is rectangular in shape and defines the length of the portion of the current collector to be covered with the lithium foil lamination, the width of the portion of the current collector to be covered with the lithium foil lamination, and a longitudinal axis of the current collector.

In some embodiments, disposing the plurality of lithium foil portions upon the portion of the current collector to be covered with the lithium foil lamination includes arranging the plurality of lithium foil portions such that the longitudinal axis of each of the plurality of lithium foil portions is parallel to the longitudinal axis of the current collector.

In some embodiments, disposing the plurality of lithium foil portions upon the portion of the current collector to be covered with the lithium foil lamination includes arranging the plurality of lithium foil portions such that the longitudinal axis of each of the plurality of lithium foil portions is perpendicular to the longitudinal axis of the current collector.

In some embodiments, the plurality of lithium foil portions includes a first plurality of lithium foil portions. The method further includes disposing a second plurality of lithium foil portions upon a reverse side of the current collector. Applying the heat and the pressure to join the first plurality of lithium foil portions to the current collector simultaneously joins the second plurality of lithium foil portions to the current collector.

In some embodiments, the plurality of lithium foil portions includes a first plurality of lithium foil portions. The method further includes, subsequent to applying the heat and the pressure to join the first plurality of lithium foil portions to the current collector, disposing a second plurality of lithium foil portions upon a reverse side of the current collector. The method further includes supplying heat and pressure a second time to join the second plurality of lithium foil portions to the current collector.

In some embodiments, applying the heat and the pressure to join the plurality of lithium foil portions to the current collector is performed once to join the plurality of lithium foil portions to the current collector simultaneously.

In some embodiments, applying the heat and the pressure to join the plurality of lithium foil portions to the current collector is performed sequentially to join the plurality of lithium foil portions to the current collector one-by-one.

According to one alternative embodiment, a method for laminating a lithium metal anode is provided. The method includes procuring a current collector, including a rectangular shaped portion of the current collector to be covered with a lithium foil lamination, wherein the current collector includes a longitudinal axis. The rectangular shaped portion of the current collector to be covered with the lithium foil lamination includes a length parallel to the longitudinal axis. The method further includes procuring a plurality of lithium foil portions. The plurality of lithium foil portions each are rectangular shaped and include a length configured for matching the length of the portion of the current collector to be covered with the lithium foil lamination and a relatively narrow width. The method further includes disposing the plurality of lithium foil portions upon the portion of the current collector to be covered with the lithium foil lamination. The plurality of lithium foil portions is arranged side-by-side and perpendicular to the longitudinal axis. The method further includes applying heat and pressure to join the lithium foil portions to the current collector.

In some embodiments, the plurality of lithium foil portions includes a first plurality of lithium foil portions. The method further includes disposing a second plurality of lithium foil portions upon a reverse side of the current collector. Applying the heat and the pressure to join the first plurality of lithium foil portions to the current collector simultaneously joins the second plurality of lithium foil portions to the current collector.

In some embodiments, the plurality of lithium foil portions includes a first plurality of lithium foil portions. The method further includes, subsequent to applying the heat and the pressure to join the first plurality of lithium foil portions to the current collector, disposing a second plurality of lithium foil portions upon a reverse side of the current collector. The method further includes applying heat and pressure a second time to join the second plurality of lithium foil portions to the current collector.

In some embodiments, applying the heat and the pressure to join the plurality of lithium foil portions to the current collector is performed once to join the plurality of lithium foil portions to the current collector simultaneously.

In some embodiments, applying the heat and the pressure to join the plurality of lithium foil portions to the current collector is performed sequentially to join the plurality of lithium foil portions to the current collector one-by-one.

According to one alternative embodiment, a method for laminating a lithium metal anode is provided. The method includes providing a flow of sheet material useful as a current collector. The method further includes providing a flow of a plurality of lithium strips, wherein the plurality of lithium strips is each relatively narrow as compared to the flow of sheet material. The method further includes directing the flow of the plurality of lithium strips upon the flow of sheet material, wherein the plurality of lithium strips is arranged side-by-side and collectively cover a top surface of the flow of sheet material. The method further includes applying heat and pressure to join the flow of the plurality of lithium strips to the flow of sheet material and create a flow of laminated material and segmenting the flow of laminated material to create the lithium metal anode.

In some embodiments, the method further includes providing a second flow of a plurality of lithium strips, directing the second flow of the plurality of lithium strips upon the flow of sheet material, and applying the heat and the pressure to additionally join the second flow of the plurality of the lithium strips to the flow of sheet material.

In some embodiments, the method further includes, prior to segmenting the flow of laminated material, storing the flow of laminated material upon a roll.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in side sectional view an exemplary battery cell including an anode, a cathode, a liquid electrolyte, and a separator, in accordance with the present disclosure;

FIG. 2 schematically illustrates a first embodiment of the anode of FIG. 1 in perspective view, in accordance with the present disclosure;

FIG. 3 schematically illustrates a second embodiment of the anode of FIG. 1 in perspective view, in accordance with the present disclosure;

FIG. 4 is a flowchart illustrating an exemplary method to laminate a current collector of an anode, in accordance with the present disclosure;

FIG. 5 is a flowchart illustrating an alternative method to laminate a current collector of an anode, in accordance with the present disclosure;

FIG. 6 schematically illustrates an exemplary lamination operation configured for laminating a plurality of lithium foil portions to a current collector, in accordance with the present disclosure; and

FIG. 7 schematically illustrates an alternative exemplary operation to create laminated anodes.

### DETAILED DESCRIPTION

Lithium may be provided as a foil or a thin sheet of material. Such a lithium foil may be provided upon a roll of material and may be created through extrusion. Lithium foil may be provided in relatively thin strips from such a roll of material, where the lithium foil has a defined width and may have a desired length. The lithium foil may be un-spooled from the roll of material and cut to the desired length. Lithium foil may be provided at a defined width which is thinner or not as wide as may be desired to cover an entire current collector surface to be used for an anode.

A method for laminating a lithium metal anode is provided. A current collector including a planar surface including a length and a width is provided. In one embodiment the current collector may be rectangular in shape. In another embodiment, a portion of the current collector to be covered with a lithium foil lamination may be rectangular in shape. An elongated strip of lithium foil with an initial strip length and a relatively narrow width is provided. The elongated strip of lithium foil is segmented into a plurality of lithium foil portions by cutting the lithium foil with at least one cut made perpendicular to the initial strip length of the lithium foil. Each of the lithium foil portions are rectangular in shape and include a portion length and the relatively narrow width of the elongated strip of lithium foil. Each of the lithium foil portions may include a same or common portion length. The plurality of lithium foil portions may be disposed to the planar surface of the current collector. The current collector with the plurality of lithium foil portions disposed thereto (or placed thereupon or situated thereto) may be put through a lamination operation, where heat and pressure are applied to the current collector and the plurality of lithium foil portions, such that the plurality of lithium portions are joined to the current collector.

A plurality of the lithium foil portions may be utilized side-by-side to cover a portion of the current collector that a single lithium foil portion could not. Each of the plurality of lithium foil portions includes a relatively narrow width and a portion length. The plurality of lithium foil portions may include a selected portion length configured for covering either a length or a width of a portion of the current collector to be laminated. By aligning a plurality of the lithium foil portions side-by-side or with the side of the lithium foil portions including the portion length aligned to/in contact with each other, a current collector of various sizes may be covered and laminated with lithium foil. In one example, a longitudinal axis of the plurality of lithium foil portions may be aligned with a longitudinal axis of the current collector. In such an example, a length of a portion of the current collector to be laminated may be utilized to set the portion length of the plurality of lithium foil portions. In such an example, the plurality of lithium foil portions may be aligned side-by-side, with multiple iterations of the relatively narrow width of the lithium foil portions being utilized to cover the width of the portion of the current collector to be laminated.

In another example, the longitudinal axis of the plurality of lithium foil portions may be aligned perpendicular to the longitudinal axis of the current collector. In such an example, a width of the portion of the current collector to be laminated may be utilized to set the portion length of the plurality of lithium foil portions. In such an example, the plurality of lithium foil portions may be aligned side-by-side, with multiple iterations of the relatively narrow width of the lithium foil portions being utilized to cover the length of the portion of the current collector to be laminated.

Lithium may be laminated onto or into an electrode structure including a metal conducting layer with an active material mixture of, for example, a nano-composite of silicon monoxide, together with graphite and a binder, such as polyvinyl di-fluoride (PVDF). The lamination of lithium metal onto or into the electrode structure reduces the amount of irreversible capacity by readily supplying an amount of lithium ions to form the initial solid electrolyte interface (SEI).

In one embodiment, in order to laminate lithium metal onto or into the negative electrode, the lithium is first deposited onto a carrier, which is then used to laminate the lithium metal onto or into the electrode structure. The coated electrode material and the lithium-deposited plastic is placed between two rollers or two plates. Plates are heated to about 120° C. or within the range of 25° C. to 250° C. A pressure of 50 kg/cm2 to 600 kg/cm2 is applied to the rollers. The speed of movement of the materials through the roller pair or the plate pair may be approximately 0.1 m/min. The method may be used for either single-sided or double-sided coating.

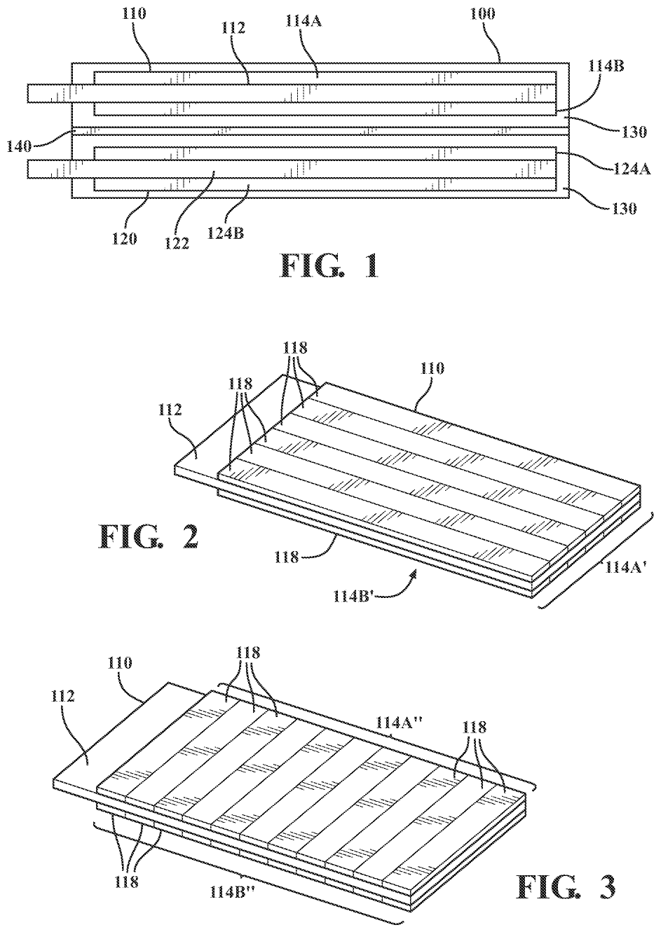

Referring now to the drawings, wherein like reference numbers refer to like features throughout the several views, FIG. 1 schematically illustrates in side sectional view an exemplary battery cell 100 including an anode 110, a cathode 120, a liquid electrolyte 130, and a separator 140. The anode 110 includes a current collector 112 and may include a lithium foil lamination 114A upon a first side of the current collector 112 and/or a lithium foil lamination 114B upon a second side of the current collector 112. The current collector 112 may be constructed of copper or other similar conductive material.

The cathode 120 includes a current collector 122 and may include a first coating 124A and/or a second coating 124B.

The anode 110 and the cathode 120 may each include additional materials, constructions, and treatments, may include different shapes, thickness, and aspect ratios, and are not intended to be limited to the embodiments described herein.

FIG. 2 schematically illustrates a first embodiment of the anode 110 of FIG. 1 in perspective view. The anode 110 includes the current collector 112. The current collector 112 may be described as including two longer sides which define a length of the current collector 112 and two shorter sides which define a width of the current collector 112. The anode further includes a plurality of lithium foil portions 118 which collectively cover a portion of the current collector 112. A group of lithium foil portions 118 upon a top surface of the current collector 112 may collectively be described as lithium foil lamination 114A′. The lithium foil portions 118 are arranged such that a longitudinal axis of each of the lithium foil portions 118 is parallel to a longitudinal axis of the current collector 112. By arranging the lithium foil portions 118 side-by-side, the lithium foil portions 118 may collectively cover a width of the portion of the current collector to be laminated.

A second group of lithium foil portions 118 may be disposed upon a bottom surface of the current collector 112 and may collectively be described as lithium foil lamination 114B′. In another embodiment, the lithium foil lamination 114B′ may be omitted from the anode 110.

FIG. 3 schematically illustrates a second embodiment of the anode 110 of FIG. 1 in perspective view. The anode 110 includes the current collector 112. The current collector 112 may be described as including two longer sides which define a length of the current collector 112 and two shorter sides which define a width of the current collector 112. The anode further includes a plurality of lithium foil portions 118 which collectively cover a portion of the current collector 112. A group of lithium foil portions 118 upon a top surface of the current collector 112 may collectively be described as lithium foil lamination 114A″. The lithium foil portions 118 are arranged such that a longitudinal axis of each of the lithium foil portions 118 is perpendicular to a longitudinal axis of the current collector 112. By arranging the lithium foil portions 118 side-by-side, the lithium foil portions 118 may collectively cover a length of the portion of the current collector to be laminated.

A second group of lithium foil portions 118 may be disposed upon a bottom surface of the current collector 112 and may collectively be described as lithium foil lamination 114B″. In another embodiment, the lithium foil lamination 114B″ may be omitted from the anode 110.

The lithium foil portions 118 of FIG. 2 and FIG. 3 are illustrated side-by-side, with side surfaces of the lithium foil portions 118 defined by the thickness of the lithium foil portions aligned with and abutting side surfaces of neighboring lithium foil portions 118. In another embodiment, edges of the lithium foil portions 118 may overlap slightly. In another embodiment, a small gap may exist between neighboring lithium foil portions. In another embodiment, the lithium foil portions 118 may not be perfectly parallel to each other. A plurality of lithium foil portions 118 may be arranged like puzzle pieces and laminated to the current collector to provide a lithium foil coating similar to lithium foil lamination 114A′ or lithium foil lamination 114A″. A number of variations to the arrangements of lithium foil portions 118 upon the current collector 112 are envisioned, and the disclosure is not intended to be limited to the examples provided.

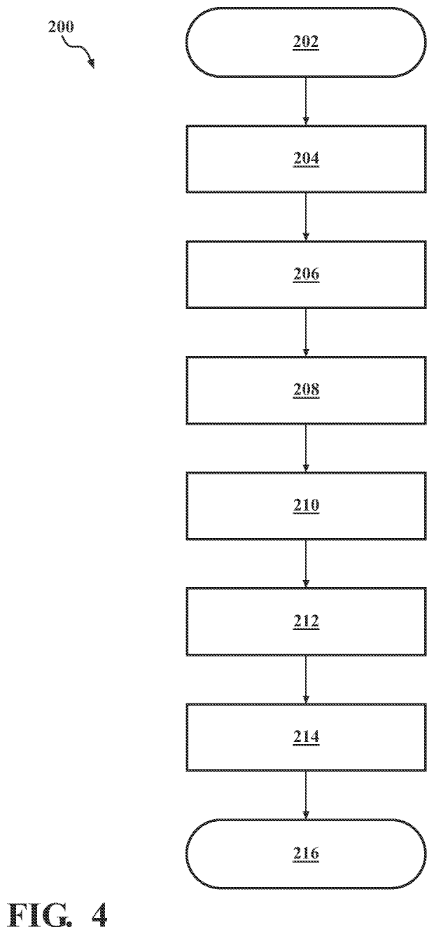

FIG. 4 is a flowchart illustrating an exemplary method 200 to laminate a current collector of an anode, wherein lithium foil portions are arranged such that a longitudinal axis of each of the lithium foil portions is parallel to a longitudinal axis of the current collector. The method 200 starts at step 202. At step 204, a current collector is procured. At step 206, an elongated strip of lithium foil is segmented or cut to create a plurality of lithium foil portions. The lithium foil portions are cut to a length selected based upon a length of a portion of the current collector to be covered by the lithium foil portions. At step 208, the lithium foil portions are arranged side-by-side upon the current collector in a pattern configured for collectively covering a portion of the current collector, with a longitudinal axis of each of the lithium foil portions aligned with and/or parallel to a longitudinal axis of the current collector. Described in another way, an elongated edge of each of the lithium foil portions is parallel to an elongated edge of the current collector, with elongated edges of neighboring lithium foil portions being in contact with each other. At step 210, heat is applied to the current collector and lithium foil portions. At step 212, pressure is applied the current collector and lithium foil portions. Steps 210 and 212 collectively represent one non-limiting embodiment of a lamination process where the lithium foil portions are joined with the current collector. In one embodiment, steps 210 and 212 may be simultaneous or a same step, for example, with pressure being applied by heated rollers. At step 214, a completed anode, with lithium foil portions collectively forming a lithium foil lamination upon one side of the current collector. At step 216, the method 200 ends. The method 200 is provided as one exemplary method with which to use a plurality of lithium foil portions to laminate a current collector. A number of additional and/or alternative method steps are envisioned, and the disclosure is not intended to be limited to the examples provided herein.

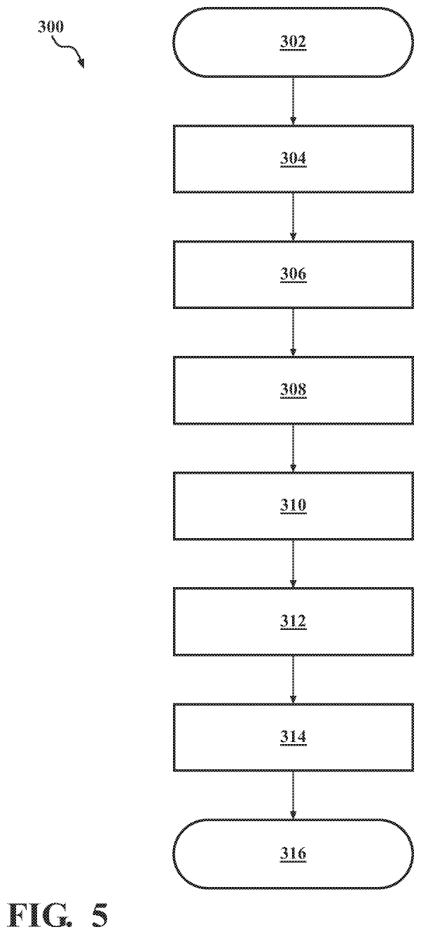

FIG. 5 is a flowchart illustrating an alternative method 300 to laminate a current collector of an anode, wherein lithium foil portions are arranged such that a longitudinal axis of each of the lithium foil portions is perpendicular to a longitudinal axis of the current collector. The method 300 starts at step 302. At step 304, a current collector is procured. At step 306, an elongated strip of lithium foil is segmented or cut to create a plurality of lithium foil portions. The lithium foil portions are cut to a length selected based upon a width of a portion of the current collector to be covered by the lithium foil portions. At step 308, the lithium foil portions are arranged side-by-side upon the current collector in a pattern configured for collectively covering a portion of the current collector, with a longitudinal axis of each of the lithium foil portions perpendicular to a longitudinal axis of the current collector. Described in another way, an elongated edge of each of the lithium foil portions is perpendicular to an elongated edge of the current collector, with elongated edges of neighboring lithium foil portions being in contact with each other. At step 310, heat is applied to the current collector and lithium foil portions. At step 312, pressure is applied to the current collector and lithium foil portions. Steps 310 and 312 collectively represent one non-limiting embodiment of a lamination process where the lithium foil portions are joined with the current collector. In one embodiment, steps 310 and 312 may be simultaneous or a same step, for example, with pressure being applied by heated rollers. At step 314, a completed anode, with lithium foil portions collectively forming a lithium foil lamination upon one side of the current collector. At step 316, the method 300 ends. The method 300 is provided as one exemplary method with which to use a plurality of lithium foil portions to laminate a current collector. A number of additional and/or alternative method steps are envisioned, and the disclosure is not intended to be limited to the examples provided herein.

The method 200 and the method 300 illustrate how one side of a current collector may be laminated with a plurality of lithium foil portions. Either method may be utilized similarly to create a current collector with lithium foil laminations on both side of the current collector. In one embodiment, both sides may be laminated simultaneously, with the lithium foil portions being disposed to both side of the current collector prior to heat and pressure being applied. In another embodiment, one of the method 200 and the method 300 may be employed to laminate a first side of the current collector, and then one of the method 200 and the method 300 may be employed to laminate a second side of the current collector. In another embodiment, each of the lithium foil portions may individually be laminated to the current collector, with a sequence of individual lamination operations joining the lithium foil portions to the current collector one by one.

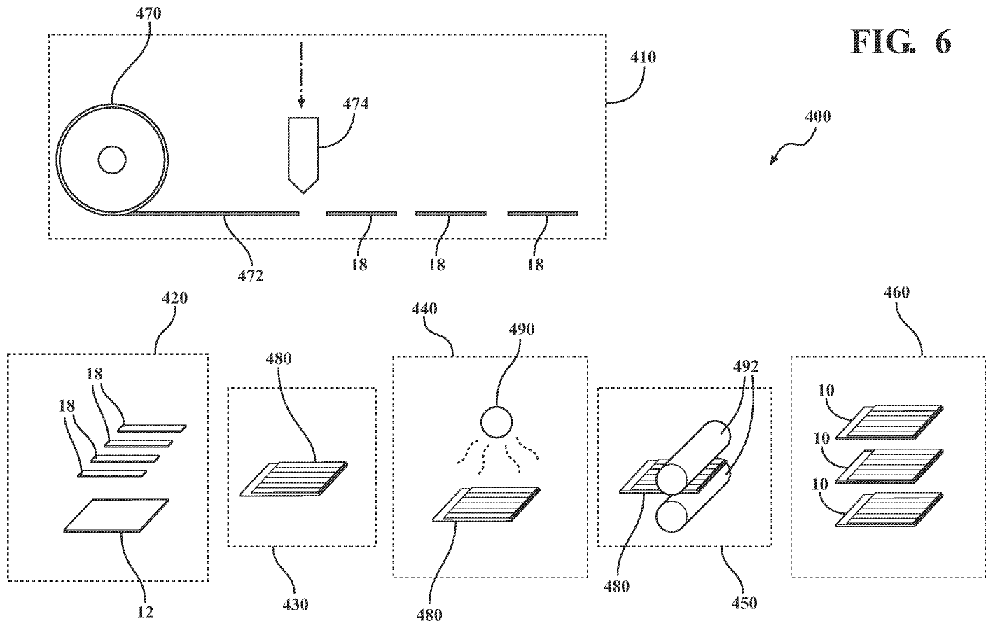

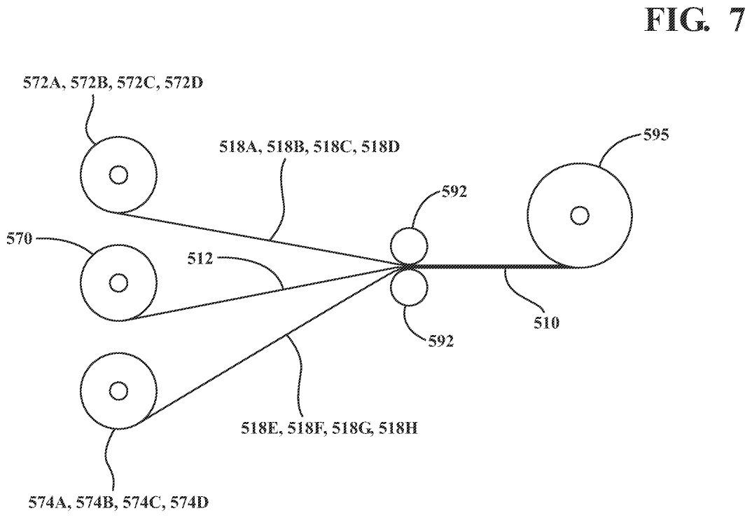

FIG. 6 schematically illustrates an exemplary lamination operation 400 configured for laminating a plurality of lithium foil portions 18 to a current collector 12. A workstation 410 is illustrated, where a roll of lithium foil 470 is utilized to create an elongated strip of lithium foil 472. This elongated strip of lithium foil 472 is cut or segmented by cutting device 474 into a plurality of lithium foil portions 18. A workstation 420 is illustrated, where a plurality of the lithium foil portions 18 created at the workstation 410 are procured. Additionally, a current collector 12 is procured. At workstation 430, the lithium foil portions 18 are aligned with and disposed upon the current collector 12 to create an in-process assembly 480. The lithium foil portions 18 may be arranged in various orientations to the current collector 12, for example, aligned according to the method 200 or the method 300 as disclosed herein. At workstation 440, a heating device 490 applies heat to the in-process assembly 480. At workstation 450, a pair of rollers 492 are used to apply pressure to the in-process assembly 480. Through application of heat and pressure, finished anodes 10 are provided at workstation 460 and may be packaged and shipped to another location for assembly into a battery or a fuel cell. The lamination operation 400 is exemplary, a number of additional and/or alternative workstations are envisioned, and the disclosure is not intended to be limited to the examples provided herein.

FIG. 7 schematically illustrates an alternative exemplary operation to create laminated anodes. A roll of material 570 useful for constructing a current collector, such as copper, is illustrated providing a flow of sheet material 512. Four rolls of lithium material, rolls 572A, 572B, 572C, and 572D, are provided arranged above the roll of material 570 providing lithium strips 518A, 518B, 518C, and 518D, respectively. Four additional rolls of lithium material, rolls 574A, 574B, 574C, and 574D are provided arranged below the roll of material 570 providing lithium strips 518E, 518F, 518G, and 518H, respectively. The lithium strips 518A, 518B, 518C, and 518D are arranged side by side and collectively cover the top surface of the flow of sheet material 512. The lithium strips 518E, 518F, 518G, and 518H are arranged side by side and collectively cover the bottom surface of the flow of sheet material 512. The flow of sheet material 512, the lithium strips 518A, 518B, 518C, and 518D, and the lithium strips 518E, 518F, 518G, and 518H are brought together, and heated rollers 592 apply heat and pressure to the flow of sheet material 512 and the various lithium strips. A flow of laminated material 510 is created. The flow of laminated material 510 may be cut into desired lengths useful to create anodes within battery cells or fuel cells. In the embodiment of FIG. 7, the flow of laminated material 510 is spooled onto roll 595, where the roll 595 may be transported to a different location and used to create laminated anodes of a desired length. Each of the lithium strips is used to cover a portion of the flow of sheet material 512, such that the plurality of the lithium strips covers an entirety of the surfaces of the flow of sheet material 512. In the embodiment of FIG. 7, both an upper and a lower surface of the flow of sheet material 512 is laminated with the lithium strips. In another embodiment, the top surface of the flow of sheet material is laminated with the lithium strips 518A, 518B, 518C, and 518D and the bottom surface is without lamination.

While the best modes for carrying out the disclosure have been described in detail, those familiar with the art to which this disclosure relates will recognize various alternative designs and embodiments for practicing the disclosure within the scope of the appended claims.

What is claimed is:

1. A method for laminating a lithium metal anode, the method comprising:
procuring a current collector, including a portion of the current collector to be covered with a lithium foil lamination;
procuring a plurality of lithium foil portions, wherein the plurality of lithium foil portions each include a length configured for matching one of a length of the portion of the current collector to be covered with the lithium foil lamination or a width of the portion of the current collector to be covered with the lithium foil lamination;
disposing the plurality of lithium foil portions upon the portion of the current collector to be covered with the lithium foil lamination, wherein the plurality of lithium foil portions is arranged side-by-side; and
applying heat and pressure to join the plurality of lithium foil portions to the current collector.

2. The method of claim 1, wherein the plurality of lithium foil portions each include:
a rectangular shape including two elongated sides and two relatively narrow sides; and
a longitudinal axis defined by the two elongated sides; and
wherein the current collector is rectangular in shape including a longitudinal axis of the current collector.

3. The method of claim 2, wherein disposing the plurality of lithium foil portions upon the portion of the current collector to be covered with the lithium foil lamination includes arranging the plurality of lithium foil portions such that the longitudinal axis of each of the plurality of lithium foil portions is parallel to the longitudinal axis of the current collector.

4. The method of claim 2, wherein disposing the plurality of lithium foil portions upon the portion of the current collector to be covered with the lithium foil lamination includes arranging the plurality of lithium foil portions such that the longitudinal axis of each of the plurality of lithium foil portions is perpendicular to the longitudinal axis of the current collector.

5. The method of claim 1, wherein the plurality of lithium foil portions each include:
a rectangular shape including two elongated sides and two relatively narrow sides; and
a longitudinal axis defined by the two elongated sides; and
wherein the portion of current collector to be covered with the lithium foil lamination is rectangular in shape and defines:
the length of the portion of the current collector to be covered with the lithium foil lamination;
the width of the portion of the current collector to be covered with the lithium foil lamination; and
a longitudinal axis of the current collector.

6. The method of claim 5, wherein disposing the plurality of lithium foil portions upon the portion of the current collector to be covered with the lithium foil lamination includes arranging the plurality of lithium foil portions such that the longitudinal axis of each of the plurality of lithium foil portions is parallel to the longitudinal axis of the current collector.

7. The method of claim 5, wherein disposing the plurality of lithium foil portions upon the portion of the current collector to be covered with the lithium foil lamination includes arranging the plurality of lithium foil portions such that the longitudinal axis of each of the plurality of lithium foil portions is perpendicular to the longitudinal axis of the current collector.

8. The method of claim 1, wherein the plurality of lithium foil portions includes a first plurality of lithium foil portions; and
further comprising:
disposing a second plurality of lithium foil portions upon a reverse side of the current collector; and
wherein applying the heat and the pressure to join the first plurality of lithium foil portions to the current collector simultaneously joins the second plurality of lithium foil portions to the current collector.

9. The method of claim 1, wherein the plurality of lithium foil portions includes a first plurality of lithium foil portions; and
further comprising:
subsequent to applying the heat and the pressure to join the first plurality of lithium foil portions to the current collector, disposing a second plurality of lithium foil portions upon a reverse side of the current collector; and
applying heat and pressure a second time to join the second plurality of lithium foil portions to the current collector.

10. The method of claim 1, wherein applying the heat and the pressure to join the plurality of lithium foil portions to the current collector is performed once to join the plurality of lithium foil portions to the current collector simultaneously.

11. The method of claim 1, wherein applying the heat and the pressure to join the plurality of lithium foil portions to the current collector is performed sequentially to join the plurality of lithium foil portions to the current collector one-by-one.

12. A method for laminating a lithium metal anode, the method comprising:
procuring a current collector, including a rectangular shaped portion of the current collector to be covered with a lithium foil lamination, wherein the current collector includes a longitudinal axis, and wherein the rectangular shaped portion of the current collector to be covered with the lithium foil lamination includes a length parallel to the longitudinal axis;
procuring a plurality of lithium foil portions, wherein the plurality of lithium foil portions each are rectangular shaped and include:
a length configured for matching the length of the portion of the current collector to be covered with the lithium foil lamination; and
a relatively narrow width;
disposing the plurality of lithium foil portions upon the portion of the current collector to be covered with the lithium foil lamination, wherein the plurality of lithium foil portions is arranged side-by-side and perpendicular to the longitudinal axis; and
applying heat and pressure to join the lithium foil portions to the current collector.

13. The method of claim 12, wherein the plurality of lithium foil portions includes a first plurality of lithium foil portions; and
further comprising:
disposing a second plurality of lithium foil portions upon a reverse side of the current collector; and
wherein applying the heat and the pressure to join the first plurality of lithium foil portions to the current collector simultaneously joins the second plurality of lithium foil portions to the current collector.

14. The method of claim 12, wherein the plurality of lithium foil portions includes a first plurality of lithium foil portions; and
further comprising:
subsequent to applying the heat and the pressure to join the first plurality of lithium foil portions to the current collector, disposing a second plurality of lithium foil portions upon a reverse side of the current collector; and
applying heat and pressure a second time to join the second plurality of lithium foil portions to the current collector.

15. The method of claim 12, wherein applying the heat and the pressure to join the plurality of lithium foil portions to the current collector is performed once to join the plurality of lithium foil portions to the current collector simultaneously.

16. The method of claim 12, wherein applying the heat and the pressure to join the plurality of lithium foil portions to the current collector is performed sequentially to join the plurality of lithium foil portions to the current collector one-by-one.

17. A method for laminating a lithium metal anode, the method comprising:
providing a flow of sheet material useful as a current collector;
providing a flow of a plurality of lithium strips, wherein the plurality of lithium strips is each relatively narrow as compared to the flow of sheet material;
directing the flow of the plurality of lithium strips upon the flow of sheet material, wherein the plurality of lithium strips is arranged side-by-side and collectively cover a top surface of the flow of sheet material;
applying heat and pressure to join the flow of the plurality of lithium strips to the flow of sheet material and create a flow of laminated material; and
segmenting the flow of laminated material to create the lithium metal anode.

18. The method of claim 17, further comprising:
providing a second flow of a plurality of lithium strips;
directing the second flow of the plurality of lithium strips upon the flow of sheet material; and
applying the heat and the pressure to additionally join the second flow of the plurality of the lithium strips to the flow of sheet material.

19. The method of claim 18, further comprising, prior to segmenting the flow of laminated material, storing the flow of laminated material upon a roll.

20. The method of claim 17, further comprising, prior to segmenting the flow of laminated material, storing the flow of laminated material upon a roll.
